(19) United States
(12) Patent Application Publication
(10) Pub. No.: US 2008/0172500 A1
(43) Pub. Date: Jul. 17, 2008

(54) MEMORY SYSTEM AND METHOD ACCESSING MEMORY ARRAY VIA COMMON SIGNAL PORTS

(75) Inventor: Jeon-Taek IM, Anseong-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 11/971,308

(22) Filed: Jan. 9, 2008

(30) Foreign Application Priority Data
Jan. 16, 2007 (KR) 10-2007-0004890

(51) Int. Cl. G06F 13/28; G06F 12/00

(52) U.S. Cl. 710/26; 711/104

(57) ABSTRACT

A memory system and method of operation are disclosed. The system includes a memory device having multiple RAMs, and a memory controller having a plurality of controllers, each one of the plurality of controllers is configured to generate an address signal and a control signal controlling read/write operations in a corresponding one of the RAMs. The memory controller includes a single common control signal output port communicating control signals generated by the controllers, and a single common address signal output port communicating address signals generated by the controllers.

### CROSS-REFERENCE TO RELATED APPLICATIONS

This U.S. non-provisional patent application claims priority under 35 U.S.C. § 119 to Korean Patent Application No. 10-2007-0004890 filed on Jan. 16, 2007, the subject matter of which is hereby incorporated by reference.

### BACKGROUND OF THE INVENTION

1. Field of the Invention

The present invention relates generally to memory systems implemented with a plurality of random access memories. More particularly, the invention relates to a memory system and method of accessing data within the system wherein independent memory controllers may access a corresponding memory via common control/address ports.

2. Description of the Related Art

Some contemporary memory systems are configured using a “single-chip” random access memory (RAM), and a corresponding memory controller. Data is communicated between these two principal elements via a multiplicity of channels (e.g., signal lines, data buses, etc.). It is common for individual controllers within the memory controller to communicate data to a corresponding RAM using a dedicated channel. Each dedicated channel communicates control, address, and payload data between a controller and RAM.

This configuration works rather well so long as the number of RAMs and controllers stays small, or the data bandwidth being communicated between controller and RAM remains reasonably narrow. Unfortunately, as the size of RAMs increases the amount of data that must be communicated to a corresponding controller also increases. At certain limits the provision of sufficient input/output (I/O) pins and related buffer circuits in the memory controller and/or the single chip memory device becomes difficult. There is only so much room within these integrated circuits.

### SUMMARY OF THE INVENTION

In one embodiment, the invention provides a memory system comprising; a memory device comprising a plurality of Random Access Memories (RAMs), and a memory controller comprising a plurality of controllers, each one of the plurality of controllers being configured to generate an address signal and a control signal controlling read/write operations in a corresponding one of the plurality of RAMs, wherein the memory controller comprises a single common control signal output port communicating control signals generated by the plurality of controllers to the memory device, and a single common address signal output port communicating address signals generated by the plurality of controllers to the memory device.

In another embodiment, the invention provides a method of accessing data in a memory system comprising a memory device comprising a first Random Access Memory (RAM) and a second RAM, and a memory controller comprising a first controller generating a first address signal and a first control signal controlling read/write operations in the corresponding first RAM, and a second controller generating a second address signal and a second control signal controlling read/write operations in the corresponding second RAM. The method comprises; communicating the first and second control signals to the memory device via a single common control signal output port, and communicating the first and second address signals to the memory device via a single common address signal output port.

### BRIEF DESCRIPTION OF THE DRAWINGS

FIG. 1 is a block diagram of a memory system in accordance with an embodiment of the invention;

FIG. 2 is a block diagram further illustrating the memory device of FIG. 1; and

FIG. 3 is a timing diagram further illustrating an exemplary read operation within the memory system shown in FIGS. 1 and 2.

### DESCRIPTION OF EMBODIMENTS

Embodiments of the invention will now be described in some additional detail with reference to the accompanying drawings. The invention may, however, be embodied in many different forms and should not be constructed as being limited to the illustrated embodiments. Rather, the embodiments are presented as teaching examples. Throughout the drawings and written description, like reference numerals refer to like or similar elements.

A memory system according to an embodiment of the invention is generally configured by operatively arranging a memory device with a memory controller. The memory device incorporates a plurality of RAMs. The memory controller incorporates a plurality of individual controllers. During operation of the memory system, the plurality of controllers forming the memory controller are configured to communicate a control signal and/or an address signal (collectively referred to “C/A signals”) to corresponding ones of the plurality of RAMs via common command input/output I/O ports. In this context, “the control signal” and/or “the address signal” may have any one of a variety of configurations including one or more individual signals communicated, data packets, multiplexed data bits, etc.

The use of common I/O signal ports to communicate various C/A signals from the memory controller to the memory device allow a substantial reduction in the number of input/output (I/O) pins ascribed to C/A signals, and a substantial reduction in the number of corresponding C/A signal buffers. Pin count reduction and signal buffer elimination allow an overall reduction in the ultimate size of the integrated circuits forming the memory system.

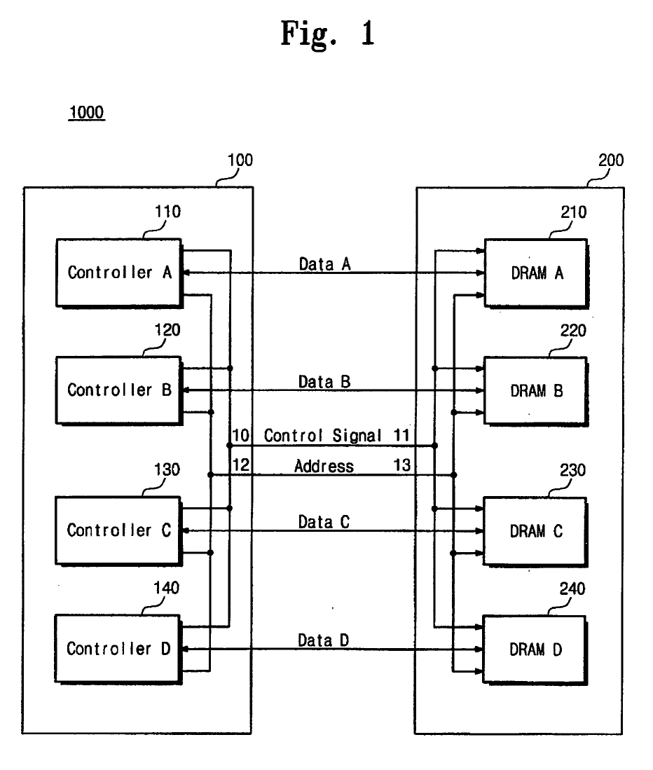

FIG. 1 is a block diagram illustrating a memory system according to one embodiment of the invention.

Referring to FIG. 1, a memory system 1000 comprises a memory controller 100 and a RAM-based memory device 200. In the illustrated embodiment, memory device 200 comprises a plurality of DRAMs 210, 220, 230, and 240, and memory controller 100 comprises a plurality of controllers 110, 120, 130, and 140, respectively associated with one of the plurality of DRAMs 210˜240.

Controllers 110˜140 of memory controller 100 provide the C/A signals necessary to access data (i.e., read and write) stored in the plurality of DRAMs 210˜240. The nature of the C/A signals will be a function of the memory system's protocol and will vary with its design. However, conventional C/A signaling associated with memory system read/write operations may be used in embodiments of the invention. Additionally, controllers 110˜140 of memory controller 100 and DRAMs 210˜240 of memory device 200 communicate read/write data. For example, controller A 110 will communicate read data A to DRAM A 210 via a data bus A, and will receive write data from DRAM A 210 via this same data bus. Controllers B-D, 120˜140, and DRAMs B-D, 220˜240, operate similarly.

However, regardless of the read/write data being communicated between an individual controller and a corresponding individual DRAM, the necessary C/A signals may be communicated via one or both of the common signal ports. That is, the address signal associated with the read/write data being communicated may be applied to a corresponding DRAM via a single address port, and control signals associated with the read/write data being communicated may be applied to the corresponding DRAM via a single control signal output port. Read/write data (Data A˜Data D) may be conventionally communicated via a data bus including constituent data I/O ports associated with each one of the plurality of DRAMs 210˜240 and the corresponding plurality of controllers 110˜140.

When memory system 1000 is operating in a normal mode, memory device 200 reads/writes data from/to memory cells in DRAMs 210˜240 according to C/A signals provided by memory controller 100. The C/A signals serve to effectively select one or more of DRAMs 210˜240 in relation to the read/write operation.

An exemplary method of selecting a DRAM (e.g., DRAM 210) from the plurality of DRAM 210˜240 in relation to a read/write operation will now be described.

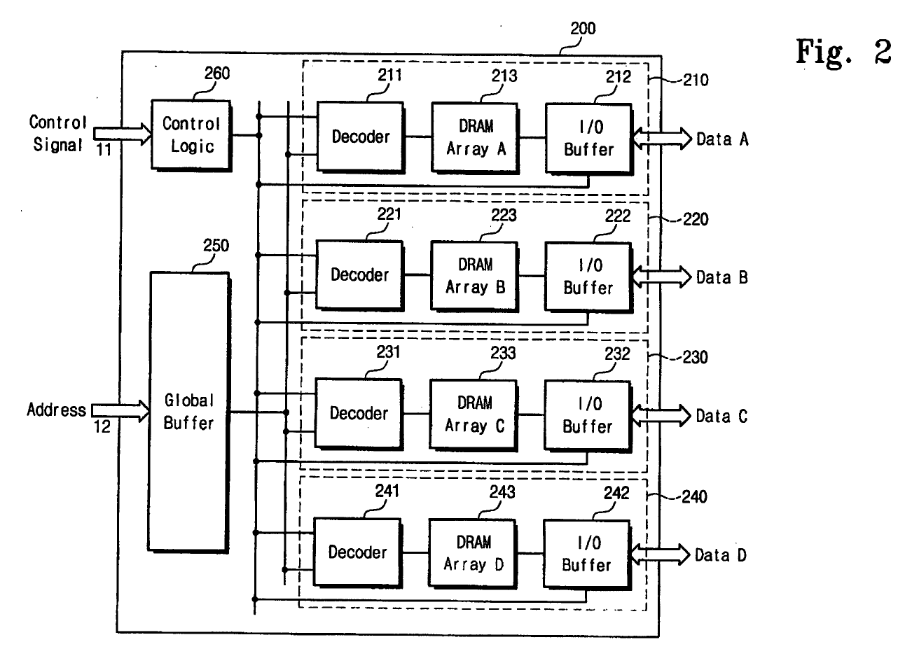

First, controller 110 of memory controller 100 provides selected DRAM 210 with the control signal via a control signal output port 10 and control signal input port 11 in order to activate or select DRAM 210. Then, controller 110 of memory controller 100 provides selected DRAM 210 with the address signal via address signal output port 12 and address signal input port 13. The receipt of C/A signals by memory device 200, and DRAM 210 within memory device 200, will be described in further detail with respect to FIG. 2. Where a write operation is performed, write data is placed on a corresponding data bus (Data A) by controller 110 and communicated to (and stored by) DRAM 210. Where a read operation is performed, read data corresponding to the address signal received by DRAM 210 is placed on the corresponding data bus (Data A) and communicated to controller 110 for further use or export by external circuits.

FIG. 2 is a block diagram further illustrating memory device 200 of FIG. 1.

Referring to FIG. 2, memory chip 200 comprises in addition to the plurality of DRAMs 210˜240, a global buffer 250, and a control logic circuit 260. Global buffer 250 receives the address signal via address signal input port 13, and control logic 260 receives the control signal via control signal input port 11. In the illustrated example, each one of the plurality of DRAMs is similarly implemented. That is, DRAM 210, comprises a DRAM array 213, a decoder 211, and an input/output buffer 212. DRAM 220 similarly comprises a DRAM array 223, a decoder 221, and an I/O buffer 222; DRAM 230 comprises a DRAM array 233, a decoder 231, and an I/O buffer 232; and DRAM 240 comprises a DRAM array 243, a decoder 241, and an I/O buffer 242.

Each one of the DRAM arrays 213˜243 in the individual DRAMS 210˜240 may be variously implemented using conventional memory cells. DRAM arrays 213˜243 may be similarly or differently configured, may be similarly of differently sized, etc.

When a particular one of DRAMs 210˜240 is activated by the control signal received via control signal input port 11, control logic circuit 260 is configured to activate the DRAM's internal circuitry, including its decoder, I/O buffer, and peripheral circuits associated with its DRAM array. Global buffer 250 commonly provides decoders 211˜241 with the address signal received via address signal input port 13.

An exemplary method of performing read/write operations in memory system 1000, made in relation to DRAM 210 as selected from the plurality of DRAMs 210˜240 signal by an assumed read/write operation, will now be described.

First, controller 110 of memory controller 100 communicates the control signal to memory device 200 via control signal output port 10 and control signal input port 11. The control signal identifies the operation to be performed and selects DRAM 210 from the plurality of DRAMs 210˜240. In this regard, control logic circuit 260 receives the control signal and activates decoder 211 and input/output buffer 212 corresponding to DRAM array 210 in response to the control signal.

Controller 110 of the memory controller 100 also provides memory device 200 with the address signal via common address output port 12. The address signal corresponding with data to be read from (or written to) certain locations in DRAM array 213 of DRAM 210. The address signal provided by controller 110 communicated via global buffer 250 connected to address signal input port 13. Global buffer 250 then commonly provides the address signal to decoders 211˜241. However, since only decoder 211 has been previously activated within selected DRAM 210, the address signal is only decoded by decoder 211 and used to read/write data in relation to DRAM array 213.

When a write operation is performed in relation to DRAM array 213 of DRAM 210 within memory system 1000, controller 110 of memory controller 100 supplies write data to a corresponding data us (Data A) connected to I/O buffer 212 of DRAM 210. Since I/O buffer 212 of DRAM array 210 has been activated by the control signal, DRAM array 213 is able to receive and store the write data using conventionally understood circuitry and methods under the control of the control signal and address signal provided by controller 110.

When a read operation is performed under the foregoing assumptions within memory system 1000, memory device 200 executes the read command in relation to DRAM 210 in response to the control signal and address signal provided by controller 110. As I/O buffer 212 of DRAM 210 has been activated by the control signal, controller 110 of memory controller 100 is able to receive read data placed on the data bus (Data A) corresponding to DRAM 210.

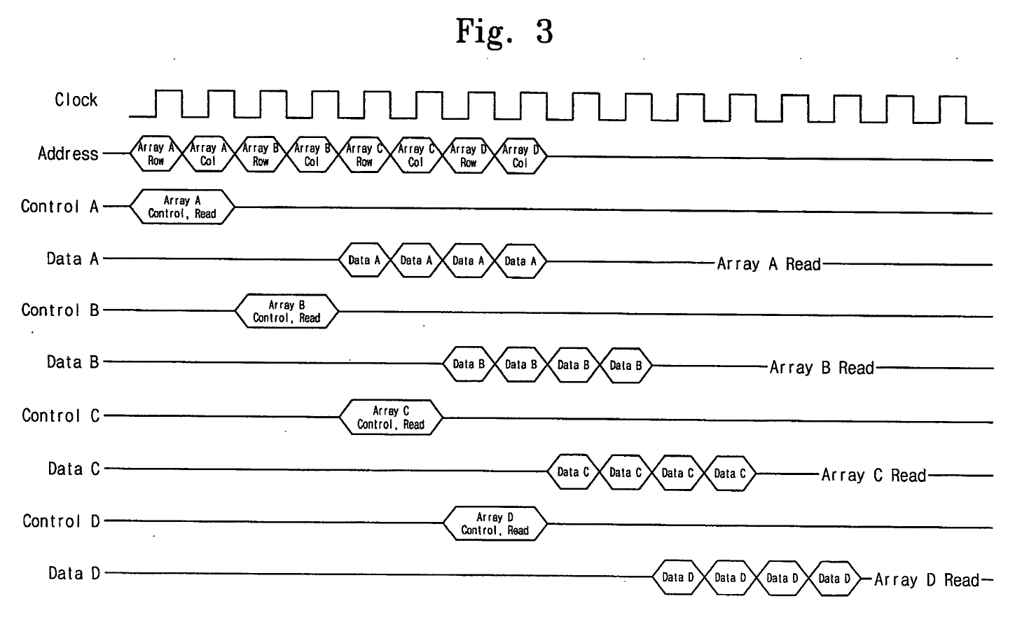

FIG. 3 is a timing diagram further illustrating a read operation performed with the memory system of FIGS. 1 and 2.

Referring to FIG. 3, address signals (e.g., first address signal, second address signal, etc.) are sequentially provided to DRAMs 210˜240 via common address output port 12. In response, the plurality of DRAMs 210˜240 successively receive row and column information via common address input port 13 and global buffer 250. (The sequential provision of address data to DRAMs 210˜240 is just a convenient example, such address signals may be randomly provided). Respective control signals (e.g., first control signal, second control signal, etc.) sequentially ascribed to DRAMs 210˜240 allow activation of the DRAMs in concert with receipt of the relevant address signal. In response to the activation and selection of each DRAM by a control signal received through control logic 260, and further in response to an applied address signal received through global buffer 260, each DRAM in the plurality of DRAMs 210˜240, outputs the identified read data on a corresponding data bus (Data A˜Data D). Thus, the sequence of control signals and address signals provided by memory controller 100 is able to effectively read data from the individual DRAMs forming memory device 200. Of further note, the read data access times (i.e., the time periods during which read data is being transferred from a DRAM to memory controller 100) via respective data buses from DRAMs 210˜240 occur at least partially in parallel within the illustrated example.

Referring to the timing diagram of FIG. 3, each address signal in the illustrated example includes separate row and column addresses, but this need not be the case. Regardless of internal address signal (or control signal) definition, however, each address signal (or control signal) is communicated from memory controller 100 to an individual DRAM in memory device 200 via common address (control) I/O ports.

The use of a single address signal output port and a single control signal output port for memory controller 100, despite the internal presence of multiple controllers operatively associated with a corresponding DRAM within memory device 200, allows a marked reduction in pin count for memory controller 100. Similarly, the use of a single address signal input port and a single control signal input port for memory device 200, despite the internal presence of multiple DRAMS operatively associated with a corresponding memory controller within memory controller 100, allows a marked reduction in pin count for memory device 100. Further, the number of I/O buffers associated with the provision of C/A signals may be correspondingly reduced.

Although the foregoing embodiment of the invention has been described in relation to a memory device having four (4) DRAMs, the number a type of memory devices used to implement memory device 200 is a matter of system design and preference.

The above-disclosed subject matter is to be considered illustrative, and not restrictive, and the appended claims are intended to cover all such modifications, enhancements, and other embodiments, which fall within the scope of the invention. Thus, to the maximum extent allowed by law, the scope of the invention is to be determined by the broadest permissible interpretation of the following claims and their equivalents.

What is claimed is:

1. A memory system comprising:
a memory device comprising a plurality of Random Access Memories (RAMs); and
a memory controller comprising a plurality of controllers, each one of the plurality of controllers being configured to generate an address signal and a control signal controlling read/write operations in a corresponding one of the plurality of RAMs,
wherein the memory controller comprises a single common control signal output port communicating control signals generated by the plurality of controllers to the memory device, and a single common address signal output port communicating address signals generated by the plurality of controllers to the memory device.

2. The memory system of claim 1, wherein the memory device further comprises:
a single common control signal input port receiving control signals generated by the plurality of controllers, and a single common address signal input port receiving address signals generated by the plurality of controllers.

3. The memory system of claim 2, wherein the memory device further comprises:
a control logic circuit connected to the single common control signal input port, receiving the control signals generated by the plurality of controllers, and communicating the control signals to the plurality of RAMs; and
a global buffer connected to the single common address signal input port, receiving the address signals generated by the plurality of controllers, and communicating the address signals to the plurality of RAMs;

4. The memory system of claim 2, wherein each one of the plurality of RAMs comprises:
a RAM array comprising an array of memory cells;
a decoder receiving the address signal generated from the corresponding one of the plurality of controllers via the global buffer; and
an input/output (I/O) buffer operating in relation to data bus associated with the RAM array in response to the control signal generated from the corresponding one of the plurality of controllers via the control logic.

5. The memory system of claim 4, wherein the decoder operates to decode the address signal and provide a decoded address to the RAM array.

6. The memory system of claim 4, wherein the I/O buffer provides data to the RAM array from the memory controller in response to the control signal during a write operation.

7. The memory system of claim 4, wherein the I/O buffer provides data to the memory controller from the RAM array in response to the control signal during a read operation.

8. The memory system of claim 1, wherein each one of the plurality of RAMs is a DRAM.

9. A method for accessing data in a memory system comprising a memory device comprising a first Random Access Memory (RAM) and a second RAM, and a memory controller comprising a first controller generating a first address signal and a first control signal controlling read/write operations in the corresponding first RAM, and a second controller generating a second address signal and a second control signal controlling read/write operations in the corresponding second RAM;
the method comprising:
communicating the first and second control signals to the memory device via a single common control signal output port; and
communicating the first and second address signals to the memory device via a single common address signal output port.

10. The method of claim 10, further comprising:
receiving the first control signal and later receiving the second control signal via control logic connected to a single common control signal input port receiving control signals from the single common control signal output port; and
receiving the first address signal and later receiving the second address signal via a global buffer connected to a single common address signal input port receiving address signals from the single common address signal output port.

11. The method of claim 10, further comprising:
decoding the first control signal to activate the first RAM and decoding the first address and applying a corresponding decoded first address signal to a RAM array of memory cells.

12. The method of claim 11, further comprising:
when the first control signal indicates a read operation providing read data from the first RAM to the memory controller in response to the first control signal and the decoded first address signal.

13. The method of claim 11, further comprising:
when the first control signal indicates a write operation receiving write data from the memory controller in the first RAM in response to the first control signal and the decoded first address signal.

14. The method of claim 9, wherein each one of the first and second RAM is a DRAM.
